(19) United States
(12) Patent Application Publication
(10) Pub. No.: US 2006/0051069 A1
(43) Pub. Date: Mar. 9, 2006

(54) Recording and reproducing device and method and program thereof

(76) Inventors: Kenichi Iida, Saitama (JP); Fumihiko Kato, Kanagawa (JP); Izuru Tanaka, Kanagawa (JP); Satoshi Mihara, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/216,058

(22) Filed: Sep. 1, 2005

(30) Foreign Application Priority Data
Sep. 2, 2004 (JP) P2004-256200

(51) Int. Cl. H04N 5/76; H04N 5/225

(52) U.S. Cl. 386/117; 348/207.99

(57) ABSTRACT

A recording and reproducing device and method and program thereof is proposed, in which editing properties of the file of voice information recorded and stored are enhanced so as to exceptionally enhance the usability. In the recording and reproducing device and method and program thereof, in case a portion of the selected file on voice information is taken as unnecessary, each image located at the starting point of time and the end point of time of the portion of the file from among each image displayed is specified, and a portion of the file corresponding to the section from the image at the specified starting point of time to the image at the end point of time is erased, and after that, the remainder of the files before and after the section is connected to each other.

### CROSS REFERENCES TO RELATED APPLICATIONS

The present invention contains subject matter related to Japanese Patent Application JP 2004-256200 filed in the Japanese Patent Office on Sep. 2, 2004, the entire contents of which being incorporated herein by reference.

### BACKGROUND OF THE INVENTION

1. Field of the Invention

The present invention relates to a recording and reproducing device and the method and program thereof, which is, for example, suitably applied to an Integrated Circuit (IC) recorder with a camera.

2. Description of the Related Art

In general, as a portable type recording and reproducing device, there has been an IC recorder. This IC recorder collects external voice by built-in microphone, and subjects the collected voice data to compression coding processing, thereby recording the collected voice in an external memory such as a semiconductor memory or memory stick (Sony Corporation Registered Trade Mark) and the like (For example, Japanese Patent Laid-Open Publication No. 2003-271280).

Such an IC recorder is configured to be small in size and light in weight, and is excellent in portability, and thus in recent years, it has come to be used in business scene such as a business meeting, a briefing, and the like, while it has also widely been used as a voice memory apparatus for personal use, apart from the business scene.

### SUMMARY OF THE INVENTION

However, in such an IC recorder, in case an unnecessary portion is erased from among the specified voice files, first, an user may perform an operation where a point of time to start and a point of time to end the unnecessary portion are specified, and this unnecessary portion is generated as a file, and after that, that file is erased, and then, the divided voice files are connected to each other.

Now, in the IC recorders of this type, there is a recorder available which has such a function that a book mark is tacked on each desired point of time for each voce file recorded and stored in the IC recorder, and reproduction can be made from the point of time existing in the book mark from among the voice files specified at the reproduction time.

However, it is extremely desirable to be able to take a portion between the desired book mark and the next book mark as an unnecessary portion by using such a book mark function and partially erase the voice file for each book mark.

The present invention has been made in view of the above described situation, and provides a recording and reproducing device and method and program thereof, which can improve editing properties of the file of voice information recorded and stored, and can bring a marked improvement of usability.

According to an embodiment of the present invention, in a portable type recording and reproducing device, there is provided a recording unit making a file of voice information outputted from a voice collection unit for each event so as to be recorded in a predetermined recording medium, and at the same time, recording the image information in the recording medium in association with the file of the corresponding voice information according to external operation; a display unit displaying each image based on said image information associated, respectively with said file of said voice information; an image specifying unit specifying each image located at a point of time to start and a point of time to end the file of each image displayed in the display unit in case the file of the voice information is erased; a file erasing unit erasing the file for the image specified by the image specifying unit, and an editing unit connecting the remainder of the files before and after the erased file after having erased the file for the image specified by the file erasing unit.

As a result, in this recording and reproducing device, in case the files of each voice information recorded and stored in the recording medium are to be erased, a user, only by specifying each image located at a point of time to start and a point of time to end the file from each image displayed in the display unit, can promptly and easily perform a series of editing operations such as connecting the remaining files before and after the section after having erased the file which corresponds to that section from the image at a point of time to start and the image at a point of time to end.

Further, in a recording and reproducing method and program according to an embodiment of the present invention, there are provided a first step of making a file of the voice information obtained by collecting external voice for each event so as to be recorded in a predetermined recording medium, and at the same time, recording the image information obtained by photographing the exterior in the recording medium in association with the file of the corresponding voice information according to external operation; a second step of displaying each image based on the image information associated with the file of each voice information; a third step of specifying each image located at a point of time to start and a point of time to end the file of each displayed image in case the file of the voice information is erased; a fourth step of erasing the file for the specified image; and the fifth step of connecting the remainder of the files before and after the section of the erased file after having erased the file for the specified image.

As a result, in the recording and reproducing method and the program, in case the files of each voice information recorded and stored in the recording medium are erased, an user can promptly and easily perform a series of editing operations such as connecting the remainder of the files before and after the section only by specifying each image located at a point of time to start and a point of time to end from each image displayed in the display unit after having erased the files which correspond to the image at a point of time to start and the image at a point of time to end.

As described above, according to an embodiment of the present invention, in the recording and reproducing device and method and program thereof, the voice information obtained by collecting external voice is made into a file for each event so as to be recorded in a predetermined recording medium, and at the same time, according to external operation, the image information obtained by photographing the exterior is recorded in the recording medium in association with the file of the corresponding voice information, and each image is displayed based on the image information associated with the file of each voice information, and in case the file of each voice information is erased, each image located at a point of time to start and a point of time to end from among each image displayed is specified, and after having erased the files corresponding to the image at the specified point of time to start and the image at the specified point of time to end, the remaining files before and after that section are connected, so that these remaining files can be easily and promptly specified based on each image displayed in the display unit of the file of the voice information that becomes an erasing object, thereby realizing a recording and reproducing device and method and program thereof, which can improve editing properties of the file of the voice information recorded and stored and bringing a marked improvement of usability.

The nature, principle and utility of the invention will become more apparent from the following detailed description when read in conjunction with the accompanying drawings in which like parts are designated by like reference numerals or characters.

### BRIEF DESCRIPTION OF THE DRAWINGS

In the accompanying drawings:

FIG. 1 is an oblique view showing an external structure at the time when a LCD cover unit of an IC recorder fitted with a camera according to the present embodiment is in a closed state;

FIG. 2 is an oblique view showing an external structure at the time when a LCD cover unit of an IC recorder fitted with a camera according to the present embodiment is in a closed state;

FIG. 3 is an oblique view showing an external structure at the time when a LCD cover unit of an IC recorder fitted with a camera according to the present embodiment is in an open state;

FIGS. 4A to 4C are schematic diagrams provided to describe a rotational state of a camera cover;

FIG. 5 is a block diagram showing an internal structure of the IC recorder fitted with a camera according to the present embodiment;

FIG. 6 is a top plan view showing a schematic structure of an event folder selection screen;

FIG. 7 is a conceptual illustration showing a directory structure of a voiscape format;

FIG. 8 is a conceptual illustration provided to describe a data structure of an event folder management file;

FIG. 9 is a conceptual illustration provided to describe a data structure of an image management file;

FIG. 10 is a flowchart showing an erasing mode processing procedure;

FIGS. 11A and 11B are schematic top plan views provided to described the display states of a menu screen and an erasing screen;

FIGS. 12A and 12B are conceptual illustrations provided to described the outline of one event erasing processing;

FIGS. 13A to 13H are schematic top plan views provided to describe the display state of the one event erasing screen;

FIG. 14 is a flowchart showing the one event erasing processing procedure;

FIGS. 15A and 15B are conceptual illustrations provided to describe the outline of all events within folder erasing processing;

FIGS. 16A and 16B are schematic top plan views provided to described the display states of an execution confirming screen and an erasing execution screen;

FIG. 17 is a flowchart showing the all events within folder erasing processing;

FIGS. 18A and 18B are conceptual illustrations provided to described the outline of a book mark erasing processing;

FIGS. 19A to 19H are schematic top plan views provided to described the display state of the book mark erasing screen;

FIG. 20 is a flowchart showing a book mark erasing processing procedure;

FIGS. 21A and 21B are conceptual illustrations provided to describe the outline of a section erasing processing;

FIGS. 22A to 22J are schematic top plan views provided to described the display state of the section erasing screen;

FIG. 23 is a flowchart showing a section erasing processing procedure; and

FIGS. 24A to 24E are conceptual illustrations provided to describe the detailed content of the section erasing processing.

### DETAILED DESCRIPTION OF PREFERRED EMBODIMENTS

An embodiment of the present invention will be described below with reference to the drawings.

(1) Configuration of IC Recorder 1 fitted with Camera according to the Present Embodiment

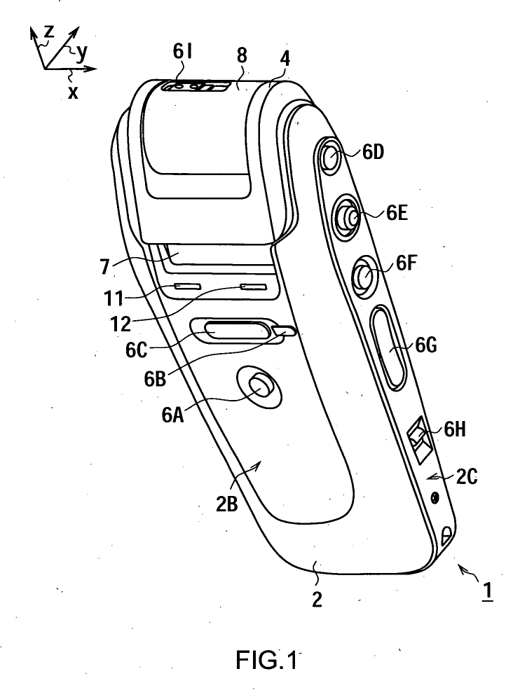

In FIGS. 1 to 3, reference numeral 11 denotes an entire IC recorder 1 fitted with a camera according to the present embodiment, and the upper portion of a main body 2 having a rounded longitudinal shape in its entirety is disposed with a LCD cover unit 4 fitted with a CCD (Charge Coupled Device) camera 3 slidable in an upper direction (arrow mark direction).

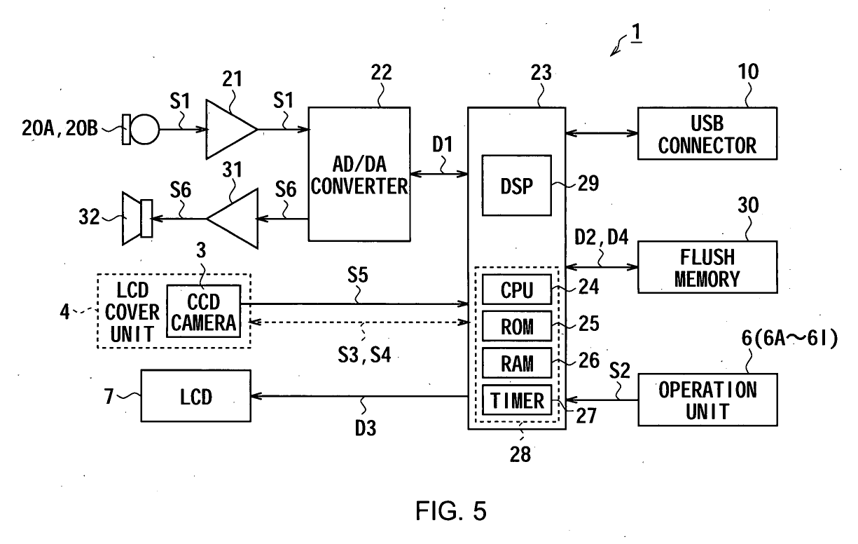

The main body 2 has both upper left and right sides of the rear surface 2A bore with voice collection holes 5A and 5B, respectively, and at the same time, has microphones 20A and 20B (FIG. 5) stored in its interior corresponding to these voice collection holes, respectively. Thus, these microphones 20A and 20B are allowed to collect exterior voice through the corresponding voice collection holes 5A and 5B.

Further, at the middle position of a front surface 2B of the main body 2, there is disposed a recording button 6A, and by depressing and operating this recording button 6A, the recording operation of the external voice collected by the microphones 20A and 20 can be started.

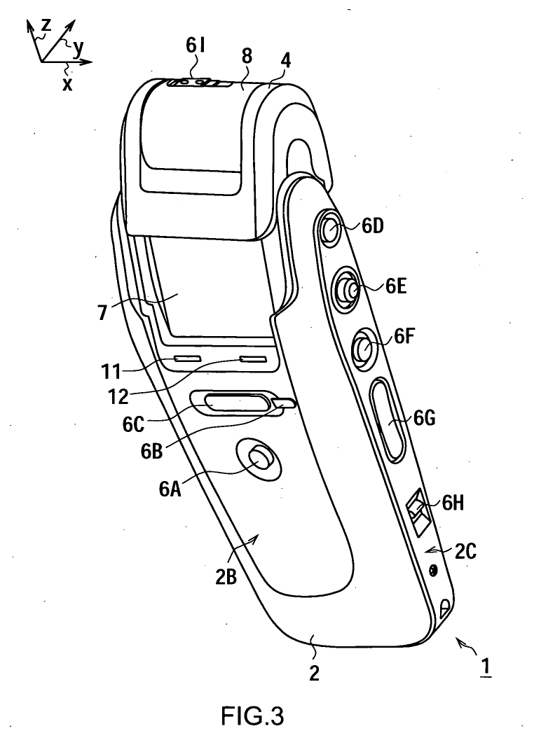

At the upper position of the front surface 2B of the main body 2, as shown in FIG. 3, there is disposed a LCD 7 including a high resolution color liquid crystal display. At the down side of this CCD 7, there is disposed a live view button 6B, and similarly to FIG. 3, in a state in which a LCD cover unit 4 is pulled upward and is put into an opened state, and moreover, as to be described later, the camera cover 8 of the LCD cover unit 4 is rotated so as to expose the CCD camera 3 and is put into an opened state, by depressing and operating this live view button 6B, a moving image imaged by the CCD camera 3 at that time can be displayed in the LCD 7.

Further, at the left side of the live view button 6B in the middle level of the front surface 2B of the main body 2, there is disposed a camera shutter button 6C, and in a state in which a moving image is displayed in the LCD 7, by depressing and operating this camera shutter button 6C, a still image for one frame at the very moment when the camera shutter button 6C is depressed and operated from among the moving images displayed in the LCD 7 can be captured and stored. In this manner, in this IC recorder 1 fitted with a camera, it is possible to store a desired still image, while directly observing and confirming the moving image displayed in the LCD 7.

On the one hand, at the right side surface 2C of the main body 2, there is disposed a menu button 6D, and by depressing and operating this menu button 6D, a predetermined menu screen can be displayed in the LCD 7. Further, at the down side of the menu button 6D in the right side surface 2C of the main body 2, there is disposed a jog lever 6E, and by operating this jog lever 6E in a manner so as to push it up and down and left and right or by depressing and operating this job lever 6E, a desired choice can be selected from various choices displayed within the menu screen or that choice can be decided as a selection object.

Further, at the down side of the job lever 6E in the right side surface 2C of the main body 2, there is disposed a stop button 6F, and at the same time, at the down side of the stop button 6F, there is disposed a volume button 6G, and by depressing and operating this stop button 6F, a recording operation and a reproduction operation can be stopped. Further, by depressing and operating the upper side or down side of the volume button 6G at the reproduction time, the volume of reproduced voice outputted from a speaker 32 (FIG. 5) disposed at the rear side of the LCD 7 at this time can be increased or decreased.

Further, at the down side of the volume button 6G in the right side surface 2C of this main body 2, there is disposed a voice up switch 6H, and by setting to turn ON this voice up switch 6H at the time of reproduction operation, at the time of the recording operation, the voice recorded in a small volume can be outputted in a large volume, while maintaining a volume of the voice recorded in a large volume as it is.

On the other hand, at the left side surface 2D of the main body 2, there is disposed a power connector 9, and by inserting a plug of a predetermined power supply kit into this power connector 9, it is possible to supply a power voltage to this IC recorder 1 fitted with a camera and perform a charging to an unillustrated battery built in the IC recorder 1 fitted with a camera.

Further, at the down side of the power connector 9 in the left side surface 2D of the main body 2, there is disposed an USB (Universal Serial Bus) connector 10, and through this USB connector 10, the external equipment such as a personal computer and the like can be connected to an USB. In this manner, in this IC recorder 1 fitted with a camera, between the external equipment thus connected to the USB, the voice data of the recorded voice and the image data of the recorded image stored in the IC recorder 1 fitted with a camera are outputted to the external equipment, and the voice data and the image data given from the external equipment can be captured.

Directly below the LCD 7 in the front surface 2B of the main body 2, there are disposed a charging LED (Light Emitting Diode) 11 to be turned ON at the time of charging and an operation LED 12 to be turned ON at the time of recording and reproduction operation, and thus based on the turning on and off states of these charging LED 11 and the operation LED 12, the user can easily detect whether or not charging, recording and the like are reliably performed.

Further, at the down side surface 2E of the main body 2, there are disposed a microphone jack 13 and a headphone jack 14, and thus by inserting the output plug of an unillustrated external microphone into the microphone jack 13, the external voice collected by the microphone can be captured and recorded.

Further, by inserting the input plug of an unillustrated external headphone into the headphone jack 14, the recorded voice reproduced at the time of reproduction operation can be heard by the headphone.

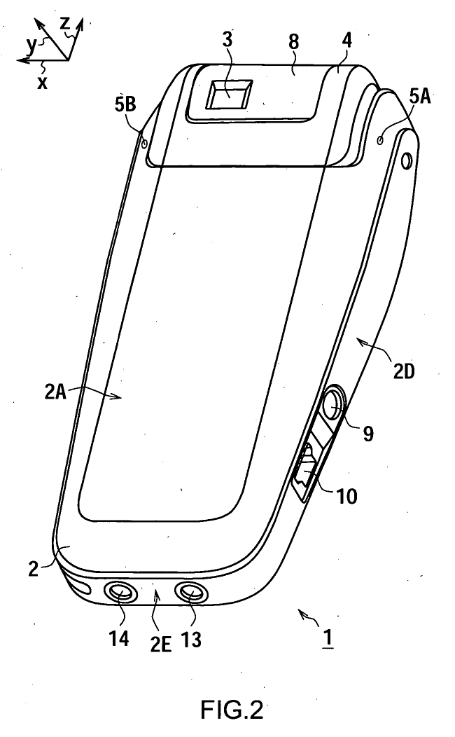

In contrast to this, the LCD cover unit 4, as shown in FIGS. 1 and 2, at the time of the closed state, has its external shape decided so as to cover approximately two thirds of the LCD 7 of the main body 2. In this manner, in this IC recorder 1 fitted with a camera, when the LCD 7 is not in use, the LCD cover unit 4 is put into a closed state, thereby making it possible to protect the LCD 7 by the LCD cover unit 4, while at the same time, when the LCD 7 is in use, as shown in FIG. 3, the LCD cover unit 4 is pulled upward so as to put the LCD 7 into an opened state, thereby exposing the LCD 7 and allowing the user to directly observe the menu screen and the like displayed in the LCD 7.

Further, at the upper part of the LCD cover unit 4, there is rotatably disposed a cylindrical camera cover 8, and at the same time, at the predetermined position of this camera cover 8, there is mounted the CCD camera 3 with its optical axis directed in a direction vertical to the center axis of the camera cover 8.

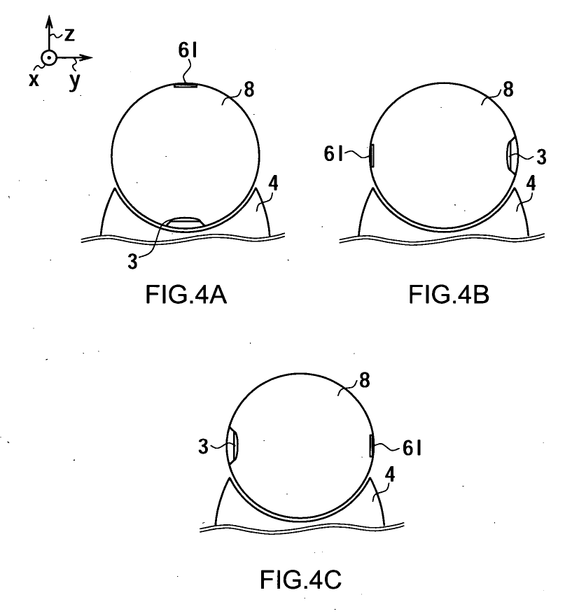

In this case, the camera cover 8, as shown in FIG. 4A, is allowed to rotate in a direction to an arrow mark a or reverse to this direction in a range from a rotational position (hereinafter, this rotational position is referred to as Zero point) in which the CCD camera 3 is hid within the LCD cover unit 4 to a rotational position (hereinafter, this rotational position is referred to as end point position) in which, as shown in FIG. 4C, the optical axis of the CCD camera 3 approximately matches the normal direction of the front surface 2B of the main body 2.

In this manner, in this IC recorder 1 fitted with a camera, as shown in FIG. 4A, the camera cover 8 is put into a closed state positioned at the Zero point so as to protect the CCD camera 3 at the non-use time, while at the same time, the camera cover 8 is rotated from this state in a direction to the arrow mark a, and as shown in FIG. 4B, by putting the CCD camera 3 into an opened state exposed to the rear surface 2A side of the main body 2, a desired image can be photographed, while directly observing the moving image displayed in the LCD 7, and by rotating the camera cover 8 from this state further to the end point in a direction to the arrow mark a, as shown in FIG. 4C, a face of the user himself can be also photographed, while directly observing the moving image displayed in the LCD 7.

Incidentally, the camera cover 8 is disposed with a macro switch 61, and by setting this macro switch 61 to ON, a macro mode can be set, which can deal with a close-up in which the CCD camera 8 is closely brought to a subject. In this case, a disposing position of such macro switch 61 is selected at a position displaced 180 degrees from the CCD camera 3, and from this, upon determining the necessity of the macro mode based on the moving image displayed in the LCD, the user can easily set the macro swatch 61 to ON when determined necessary.

(2) Internal Structure of IC Recorder Fitted with Camera

Here, FIG. 5 shows an internal structure of the IC recorder 1 fitted with a camera.

In this IC recorder 1 fitted with a camera, when the power is turned on, the microphones 20A and 20B collect external voice, and transmits the obtained voice signals S1 to an AD (Analogue Digital)/DA (Digital Analogue) converter 22 through an amplifier 21. Further, the AD/DA converter 22 subjects the voice signals S1 given from the microphones 20A and 20B in order to digital conversion processing, and transmits the obtained voice data D1 in order to a data processing and controller 23.

The data processing and controller-23 is configured to have a controller 28 of a micro computer structure including a Central Processing Unit (CPU) 24 in charge of the control of the entire IC recorder 1 fitted with a camera, a Read Only Memory (ROM) 25 stored with programs of various types, a RAM (Random Access Memory) 26 as a work memory of the CPU 24 and a built-in timer 27, and a Digital Signal Processor (DSP) 29 having a voice data D1 and a data compression expansion function for an imaged data D3 to be described later.

The controller 28 of the data processing and controller 23 is given a corresponding operation input signal S2 from the operation unit 6 when any of the recording button 6A, the live view button 6B, the camera shutter button 6C, the menu button 6D, the jog lever 6E, the stop button 6F, the volume switch 6G, the voice up switch 6H and the macro switch 6I, which configure the operation section 6, is operated.

Further, the controller 28 is given from a corresponding sensor (not shown) provided within the LCD cover unit 4 a LCD cover state signal S3 showing that the LCD cover unit 4 is either in a closed state (FIGS. 1 and 2) or an opened state (FIG. 3) and a camera cover state signal S4 showing that the camera cover 8 is either in a closed state (FIG. 4A) or an opened state (FIGS. 4B and 4C), respectively.

Thus, the CPU 24 of the controller 28 recognizes the operation content of the user operation based on the operation input signal S2, and at the same time, based on the LCD cover state signal S3 and the camera cover state signal S4, detects the current states of the LCD cover unit 4 and the camera cover 8, and based on these recognition, detection result, and various types of control programs stored in the ROM 25, executes corresponding various types of control processings.

In reality, the CPU 24, when recognizing that the recording button 6A of the operation section 6 is depressed and operated based on the operation input signal S2, determines the states of the LCD cover unit 4 and the camera cover 8 based on the LCD cover state signal S3 and the camera-cover state signal S4, and when detecting that at least either of the LCD cover unit 4 or the camera cover 8 is in a closed state, shifts an operation mode to a recording mode accordingly, thereby controlling the DSP 29. Thus, at this time, under such control of the CPU 24, the DSP 29 gives a voice compression processing to the voice data D1 given from the AD/DA converter 22 in conformity to a predetermined voice compression system such as LPEC (Sony Corporation Registered Trade Mark) and the like, and stores the obtained compressed voice data D2 in order in a flush memory 30.

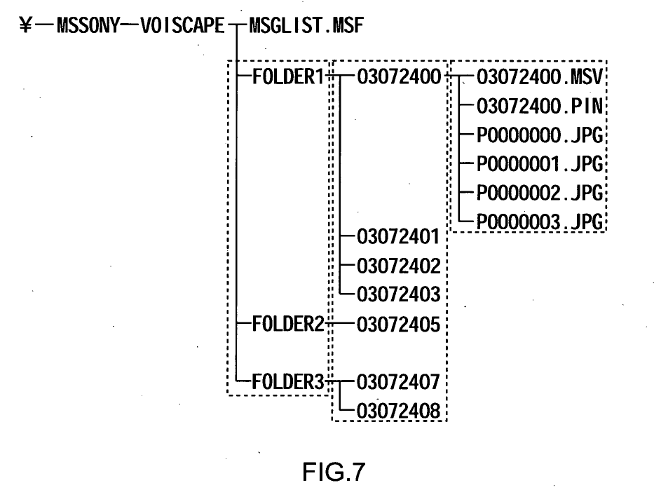

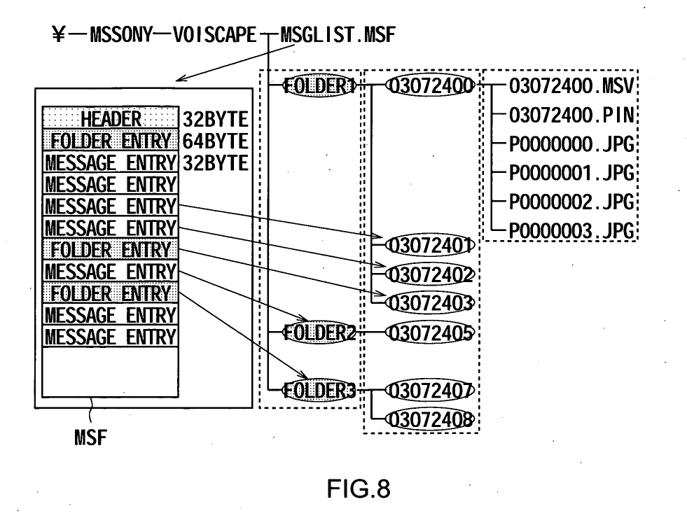

Further, the CPU 24, after this, when recognizing that the stop button 6F is depressed and operated based on the operation input signal S2, controls the DSP 29 so as to stop the voice compression processing for the voice data D1 given from the AD/DA converter 22, while at the same time, generates new event folders (“03072400” and “03072408” of FIG. 7) within folders (“FOLDER 1” to “FOLDER 3” of FIG. 7) selected by the user at that time, and stores the voice file (“0372400.MSV” of FIG. 7) including such compressed voice data D2 into that event file, and stores management information on that event folder into a management file (“MSGLIST.MSF”of FIG. 8) to be described later.

Further, the CPU 24, when detecting that both the LCD cover unit 4 and the camera cover 8 are in an opened state based on the LCD cover state signal S3 and the camera cover state signal S4, shifts the operation mode to the camera mode and controls the CCD camera 3, thereby activating the CCD camera 3. As a result, image signals S5 relating to a scene photographed by the CCD camera 3 at that time are outputted from the CCD camera 3 in order, and these are given to the data processing and controller 23.

The CPU 24, in this state, when recognizing that the live view button 6B is depressed and operated based on the operation input signal S2, controls the DSP 29 accordingly. Thus, at this time, the DSP 29 converts such image signal S5 given from the CCD camera 3 into a digital signal in order, and transmits the obtained image data D3 to the LCD 7. As a result, moving images relating to the scene photographed by the CCD camera 3 at that time based on this image data D3 are displayed in the LCD 7 in real time.

Further, the CPU 24, after this, in this state, when recognizing that the camera shutter button 6C is depressed and operated based on the operation input signal S2, controls the DSP 29 accordingly. Thus, at this time, the DSP 29 captures the image data D3 of the still image for one frame obtained based on the image data D3 at the very moment when the camera shutter button 6C is depressed, and gives to this captured image data D3 an image compression processing in conformity to a predetermined image compression system, for example, such as JPEG (Joint Photographic Experts Group) and the like, and stores the obtained compressed image data D4 in the flush memory 30.

The CPU 24, after that, generates new event folders within the folder selected by the user at that time, and stores such image files (“P0000000.JPG” to “P0000003.JPG” of FIG. 7) including the compressed image data D4 into the event folders, and stores the management information on the event folders in the management file.

In the meantime, the CPU 24, when recognizing that the recording button 6A is depressed and operated based on the operation input signal S2, determines the states of the LCD cover unit 4 and the camera cover 8 based on the LCD cover state signal S3 and the camera cover state signal S4, and when detecting that both the LCD cover unit 4 and the camera cover 8 are in a closed state, shifts the operation mode to an audio recording and video taping mode, and at the same time, controls DSP 29 accordingly.

At this time, the DSP 29, similarly to the audio recording mode time, gives to the voice data D1 given from the AD/DA converter 22 the predetermined voice compression processing in order and stores the obtained compressed voice data D2 in the flush memory 30. Further, at this time, the DSP 29, similarly to the camera mode time, digital-converts the image signal S5 given from the CCD camera 3 in order, and transmits the obtained image data D3 to the LCD 7. As a result, the LCD 7 is displayed with the moving image relating to the scene photographed by the CCD camera 3 at this time based on this image data D3 in real time.

Further, the CPU 24, after this, in this state, when recognizing that the camera shutter button 6C is depressed and operated based on the operation input signal S2, controls the DSP 29 accordingly. At this time, the DSP 29, similarly to the camera mode time, captures the image data D3 of the still image for one frame obtained based on the image signal S5 given from the CCD camera 3 at the very moment when the camera shutter button 6C is depressed, and gives to this captured image data D3 the image compression processing.

Further, the DSP 29, after that, takes the compressed image data D4 obtained by such image compression processing as the compressed image data D4 of the image (hereinafter, this is referred to as bookmark image) that becomes an earmark when detecting afterward the moment in which the camera shutter button 6C is depressed and operated, and stores the data D4 in the flush memory 30 in association with the position corresponding to the compressed voice data D2 stored in order in the flush memory 30.

The CPU 24, after that, when recognizing that the stop button 6F is depressed and operated based on the operation input signal S2, generates a new event folder within the folder selected by the user at that time, and stores the voice file including such compressed voice data D2 and each image file including each compressed image data D4 associated with the voice file into that event folder, and stores the management information on the event folder in the management file.

In this manner, in this IC recorder 1 fitted with a camera, not only the voice and the still image can be recorded independently, but also the still image can be recorded as a bookmark image in association with the voice during recording.

In this IC recorder 1 fitted with a camera, based on the bookmark image recorded in association with the voice in this manner, the desired event folder and the desired voice position within the event folder can be retrieved.

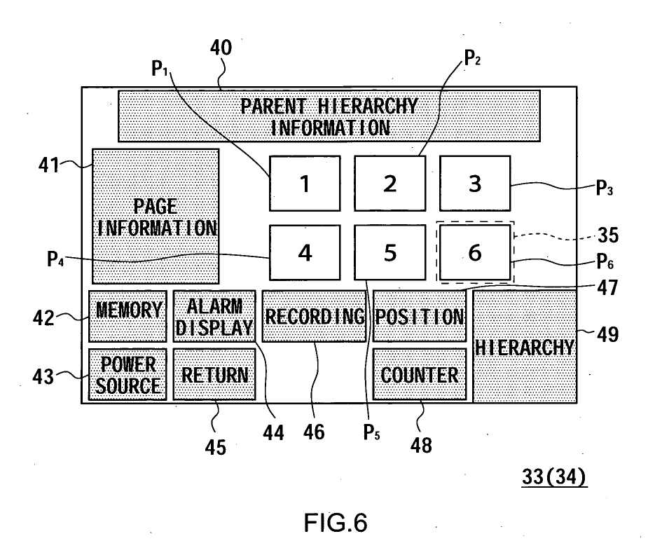

In reality, the CPU 24, when recognizing that a display command of a selection screen (hereinafter, this is referred to as an event folder selection screen) for selecting the desired event folder within the desired folder or a selection screen (hereinafter, this is referred to as a bookmark image selection screen) for selecting the desired bookmark image within the event folder when the jog lever 6E is depressed and operated is inputted based on the operation input S2, reads out the corresponding image data D3 from the ROM 25 and transmits it to the LCD 7, so that a event folder selection screen 33 as shown in FIG. 6 and a bookmark image selection screen 34 (FIG. 6) having the same structure as the event folder selection screen 33 are displayed in the LCD 7.

In this case, the CPU 24, when allowing the event folder selection screen 33 to be displayed in the LCD 7, reads out the image file (compressed image data D4) of the representative bookmark image (hereinafter, this is refereed to as a representative image) set in advance relating to each event folder within the folder from the flush memory 30, and allows that image file to be subjected to a decoding processing by the DSP 29, and prepares thumbnail images P1 to P6 of a predetermined size based on the obtained image data D3.

The CPU 24, as shown in FIG. 6, allows the thumbnail images P1 to P6 for each event folder thus obtained to be displayed in a list within the event folder selection screen 33. Incidentally, at this time, with regard to the event folder that does not include the still image having voice only, a predetermined icon is displayed in replacement of the thumbnail images.

Further, the CPU 24, after that, when the jog lever 6E is operated and one of the thumbnails P1 to P6 within the event folder selection screen 33 is selected, reads out the voice file (compressed voice data D2) within the corresponding event folder from the flush memory 30 based on the management file, and allows this voice file to be subjected to the decoding processing by the DSP 29.

As a result, the voice data D1 obtained by such decoding processing is outputted from the DSP 29, and this data D1 is analogue-converted by the AD/DA converter 22, and the obtained voice signal S6 is given to the speaker 32 through an amplifier 31. In this manner, at this time, the voice based on this voice signal S6 is outputted from the speaker 32.

Similarly to this, the CPU 24, when allowing the book mark image selection screen 34 (FIG. 6) to be displayed in the LCD 7, reads out the image files (compressed image data D4) of each book mark image within the corresponding event folder from the flush memory 30 based on such management file, and allows these files to be subjected to the decoding processing by the DSP 29, and prepares the thumbnail images P1 to P6 of a predetermined size based on each of the obtained image data D3. The CPU 24 allows the thumbnail images P1 to P6 for each book mark image thus obtained to be displayed in a list within the book mark image selection screen 34.

Further, the CPU 24, after that, when the jog lever 6E is operated, and one of the thumbnail images P1 to P6 within the book mark image selection screen 34 is selected, reads out the compressed voice data D2 subsequent to the voice portion corresponding to the original book mark image of the thumbnail images P1 to P6 in the corresponding voice file from the flush memory 30, and allows the data D2 to be subjected to the decoding processing by the DSP 29.

As a result, the voice data D1 obtained by such decoding processing is outputted from the DSP 29, and this voice data D1 is analogue-converted by the AD/DA converter 22, and the obtained voice signal S6 is given to the speaker 32 through the amplifier 31. In this manner, based on the voice signal S6, the voice subsequent to the voice position corresponding to the book mark image selected by the user in the selected event folder is outputted from the speaker 32.

In this manner, in this IC recorder 1 fitted with a camera, based on the representative image of the event folder and each book mark image within the event folder, the desired event folder and the desired voice position within the event folder can be accessed quickly and easily.

In addition to such configuration, in the case of this IC recorder 1 fitted with a camera, with regard to the event folder including the voice file, it is possible to record a new book mark image at the reproduction time of the voice file, and further, with regard to the event folder including the image file only, it is possible to record a new book mark image in association with the voice afterwards.

In reality, the CPU 24 detects that both the LCD cover unit 4 and the camera cover 8 are in an opened state based on the LCD cover state signal S3 and the camera cover state signal S4, and in a state in which the voice file of the event folder selected by the user is reproduced as described above, the CPU 24, when recognizing that the camera shutter button 6C is depressed and operated based on the operation input signal S2, controls the DSP 29 accordingly.

At this time, under such control of the CPU 24, the DSP 29 captures the image data D3 of the still image for one frame which is obtained based on the image signal S5 given from the CCD camera 3 at the very moment when the camera shutter button 6C is depressed, and gives to this captured image data D3 the image compression processing. After this, the DSP 29 stores the compressed image data D4 obtained by such image compression processing in the flush memory 30 as the image file of the book mark image at the very moment when the camera shutter button 6C is depressed and operated in association with the voice file reproduced at that time.

In the meantime, the CPU 24, when recognizing that the recording button 6A is depressed and operated based on the operation input signal S2 after the event folder including the image file only is selected in the event folder selection screen 33 (FIG. 6) displayed in the LCD 7 and an instruction to the effect that additional recording be performed for the event folder by the predetermined operation using the jog lever 6E is inputted, controls the DSP 29 accordingly.

Thus, at this time, under such control of the CPU 24, the DSP 29 gives the voice compression processing to the voice data D1 given from the AD/DA converter 22, and stores the obtained compressed voice data D2 in the flush memory 30 as a voice file in association with that image file. Incidentally, in this case, the still image based on the original image file is automatically set to the book mark image at the initial position of the voice additionally recorded.

In this manner, in this IC recorder 1 fitted with a camera, additional recording of the book mark image can be freely made afterwards on the desired position of the recorded voice and additional recording on the recorded still image in association with the voice afterwards can be made, so that retrieval properties of the desired portion of the recorded voice can be enhanced, and functionality as the IC recorder can be enhanced.

(3) Directory Configuration of Data Management Format in IC Recorder fitted with Camera

Next, the directory configuration of a voiscape format (Voiscape Format) which is a data management format of the compressed voice data D2 and the compressed image data D4 adapted in this IC recorder 1 fitted with a camera will be described.

FIG. 7 shows the directory configuration of such voiscape format. As shown in FIG. 7, the voice file (“03072400.MSV”) of the recorded voice and the image files (“P0000000.JPG” to “P0000003.JPG”) of the book mark images recorded in association with this file are stored in a folder referred to as “VOISCAPE” prepared within the folder referred to as “MSSONY”.

The folders (“FOLDER 1” to “FOLDER 3”) storing the event folder exists within this “VOISCAPE”, and the user can select a desired folder as a storing place of the voice file and the like of the recorded voice from among these folders, and can prepare a new folder.

Further, the “VOISCAPE” is also stored with the management file (“MSGLIST.MSF”) for managing the prepared event folder. This management file, as shown in FIG. 8, has a data structure described in order for each folder with a folder entry (“Folder Entry”) described with the folder name and the like of each folder (“FOLDER 1” to “FOLDER 3”) and a message entry (“Message Entry”) described with the folder name of each event folder prepared within the folder and the preparation date and the like of the event folder subsequently to the header (“Header”) of 32 “Byte” where the date, the time, the minute, the second, the day of week, and the like when the management file has been finally edited are described.

In this voiscape format, when a new folder and a new event folder are prepared, the folder entry and the message entry in which various pieces of management information as described are described are certainly registered in the management file. In this manner, in this voiscape format, based on this management file, it is possible to reliably and promptly retrieve in which folder the desired event folder is located.

Further, within each folder (“FOLDER 1” to “FOLDER 3”), according to the using situation of each user, one or plural event folders (“03072400” to “03072408”) are prepared, and within each of these event folders, the voice file (“03072400.MSV”) of the compressed voice data D2 obtained by audio recording, the image files (“P0000000.JPG” to “P0000003.JPG”) of the compressed image data D4 of each book mark image photographed during such audio recording, and the image management file (“03072400.PIN”) for managing each image file are stored.

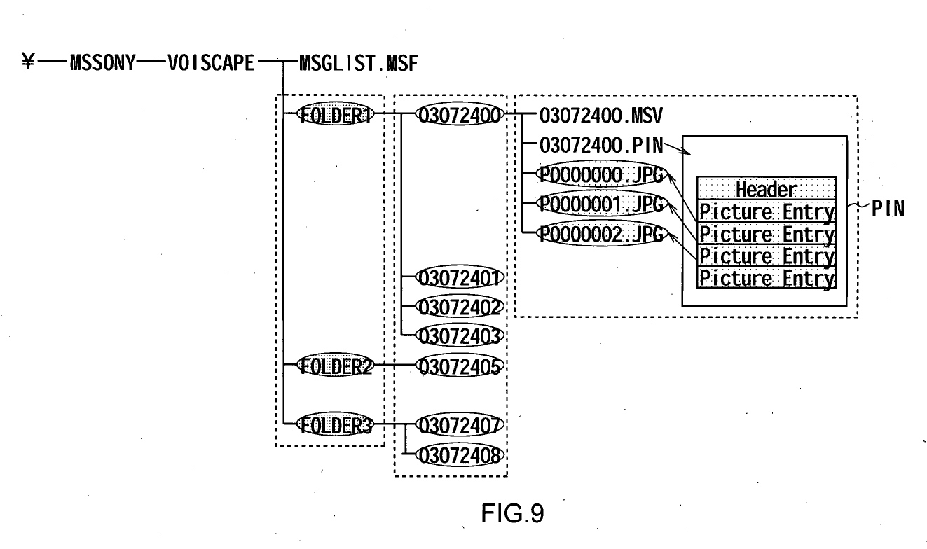

The image management file (“03072400.PIN”), as shown in FIG. 9, has a data configuration in which, subsequently to the header where the date, the time, the minute, the second, the day of the week and the like when this image management file has been finally edited are described, plural picture entries (“Picture Entry”) are disposed.

In this case, the first picture entry is described with the corresponding positions (time, minute, and second) and the like for the file name of the image file of the book mark image where the representative image is set and the voice file (voice data D1) of the book mark image. Incidentally, in case the representative image is not set, all the portions of the first picture entry other than the picture ID showing that the area described at the starting head of each picture entry is a picture entry are stored with Zero data.

Further, the picture entry subsequent to the second picture entry is described with the file name of the image file of each book mark image photographed during audio recording of the corresponding voice and the corresponding positions (time, minute, and second) and the like for the voice of the book mark image. In this case, since the picture entries subsequent to the second picture entry are added in order in the rear every time the image file of a new book mark image is registered, a line up order of the picture entries subsequent to the second picture entry in the image management file represents an order of the position corresponding to the image file from the starting head of the corresponding voice.

In this manner, in this voiscape format, based on this image management file, the corresponding positions for the representative image of the event folder and the voice of the book mark image can be retrieved. Further, in this manner, by storing the voice file and the image file of each book mark image associated with this voice file in the same folder (event folder), when these data are captured by the external personal computer and seen by an explorer, it is easy to recognize the relation between the voice file and the image file, and as a result, the erroneous erasing by the user of the voice file and the image file can be prevented.

Incidentally, a specific data configuration of the header and the picture entry in the image management file are shown in FIGS. 8 and 9.

As evident from these figures, the header (“HEADER”) of the image management file is configured to have a picture index ID information (“PIND-ID”), version information (“FMT-VER”), maker code information (“MCode”), final editing data information (“YMDHMSW”), the total number of entries information (“ENTRY-NUM”), picture entry size information (“PSIZE”), offset information (“OFFSET”), and character code information (“CCODE”).

In this case, the picture index ID information (“PIND-ID”) represents an ID showing that this file is the image-management file, and a predetermined fixed value is used. Further, the version information (“FMT-VER”) is the information showing the version number of this voiscape format, and is described with the corresponding code.

Further, the maker code information (“Mcode”) is information showing the maker and the model of the equipment which has finally edited this image management file, and is described with the corresponding code, and the final editing data information (“YMDHMSW”) is information showing the date, the time, the minute, the second, the day of the week, and the like when this image management file has been finally edited, and is renewed every time a new book mark image is registered and its picture entry is added.

Further, the total number of entries information (“ENTRY-NUM”) shows the total number (equivalent to the total number of the book mark images stored in the corresponding event folder) of picture entry registered in this image file, and is renewed every time a new picture entry is registered, and the picture entry size information (“PSIZE”) shows a data size for each picture entry in this image management file, and is described by a byte (Byte) unit.

Further, the offset information (“OFFSET”) shows the starting position of the first picture entry by the offset from the starting head of the image management file, and is described in a unit of byte (Byte), and the character information (“CCODE”) shows a character code and a language used by this image management file.

In the meantime, as evident from the figures, the picture entry (“Picture Entry”) in the image management file is configured to have picture entry ID information (“PID”), image attribute information (“PIA”), corresponding position information (“POSITION”), file name information (“FILE-NAME”), and a reserve (“R”).

In this case, the picture entry ID information (“PID”) represents an ID showing the starting head of the picture entry, and is described with a predetermined fixed value. Further, the image attribute information (“PIA”) is information showing whether the corresponding book mark image is a still image obtained by photographing or an icon prepared in advance, and in case it is the still image obtained by photographing, the file name of that image file is described, and in case it is the icon prepared in advance, the icon number given in advance for the icon is described.

Further, the corresponding position information (“POSITION”) shows the corresponding position of the corresponding book mark image in the voice file within the same event folder, and is described with the offset amount from the starting head of the voice based on the voice file in a unit of millisecond. Incidentally, the corresponding position information in the first picture entry is fixed to “0”. Further, the file name information (“FILE-NAME”) shows the file name of the image file of the corresponding book mark image.

(4) Operation Method in Event folder Selection Screen and the like

Next, the operation methods in the event folder selection screen 33 and the book mark image selection screen 34 described in FIG. 6 will be described. However, since the operation methods in the event folder selection screen 33 and the book mark image selection screen 34 are quite the same, a description will be made on the event folder selection screen 34 as an example as follows.

This IC recorder 1 fitted with a camera can allow the event folder selection screen 33 shown in FIG. 6 to be displayed in the LCD 7 by the predetermined operation as described above.

In this case, this event folder selection screen 33 is provided with a parent hierarchy information display 40 for displaying the folder name of the folder of the parent hierarchy, a page information display 41 including, for example, a scroll bar, a memory remaining amount display 42 and the power source remaining amount display 43 for displaying the memory remaining amount of the flush memory 30 and the remaining energy amount of the power source, an alarm mark display 44 and a repeat mark display 45 for displaying the repeat mark when the alarm mark or the repeat mode are set, a position display 47 for displaying which number event folder is specified from among the total number of event folders in which a cursor 35 to be described later is included, a counter display 48 for displaying an elapsed time from the reproduction starting time to the present time when the voice folder is reproduced, and a hierarchy display 49 for displaying the hierarchy of the selection screen to be displayed in the LCD 7 (FIG. 5).

Incidentally, in the case of this IC recorder 1 fitted with a camera, as the hierarchy, there are three types available starting in order from the upper hierarchy to a “folder hierarchy”, an “event hierarchy”, and a “bookmark hierarchy”. Consequently, in the case of the event folder selection screen 33, the folder name of the folder selected at that time is displayed in the parent hierarchy information display 40, and when the jog lever 6E is operated for hierarchy change, the display screen is changed to the book mark selection screen 34 for the event folder pointed by the cursor 35 at that time. Incidentally, in the case of the book mark image selection screen 34, the folder name of the event folder selected at that time is displayed in the parent hierarchy information display 40, and when the jog lever 6E is operated for hierarchy change, the display screen is changed to an unillustrated predetermined folder selection screen for selecting a desired folder.

In this event folder selection screen 33, at the initial time, with regard to the upper six event folders that are early in the preparation date from among each of the event folders stored in the selected folder, the thumbnail images P1 to P6 of the book mark images set in advance as the representative images of the event folder are displayed in a list. At this time, when the event folder is only the voice file that does not include the image file or the representative image is not set up, the icon set in advance as described above is displayed.

Further, in this event folder selection screen 33, a cursor 35 is displayed, which surrounds one of the thumbnail images P1 to P6 (hereinafter this state is referred to as “specify the thumbnail images P1 to P6”). The user depresses long the jog lever 6E (FIGS. 1 to 3) to a fast forwarding (“FF”) side during reproduction or stopping reproduction of the voice file, so that the cursor 35 can be moved in order so as to specify the thumbnail images P1 to P6 of the next event folder, while, in contrast to this, during reproduction or stopping reproduction of the voice file, the jog lever 6E is depressed long to a fast rewinding (“FR”) side, so that the cursor 35 can be moved in order so as to specify the thumbnail images P1 to P6 of the preceding event folder.

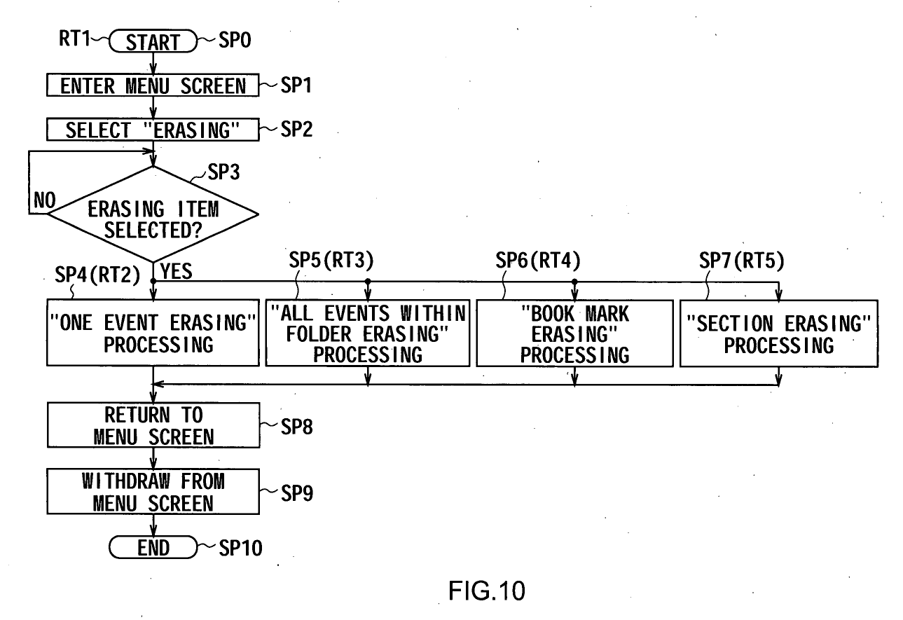

Further, in the event folder selection screen 33, in a state in which the cursor 35 specifies the last thumbnail image P6 of the event folder from among the six thumbnail images P1 to P6 displayed at that time, the jog lever 6E is further depressed long to the fast forwarding (“FF”) side, so that, as shown in FIG. 10, with regard to the next six event folders stored in that folder, the thumbnail images P1 to P6 of the book mark image set in advance as the representative image of the event folder can be displayed in order.

Similarly, in the event folder selection screen 33, in a state in which the cursor 35 specifies the first thumbnail image P1 of the event folder from among the six thumbnail images P1 to P6 displayed at that time, the jog lever 6E is further depressed long to the fast rewinding (“FR”) side, so that, as shown in FIG. 10, with regard to the previous six event folders stored in that folder, the thumbnail images P1 to P6 of the book mark image set in advance as the representative image of the event folder can be displayed in order.

Thus, the user, based on the thumbnail images P1 to P6 displayed in the event folder selection screen 33 by such operation of the jog lever 6E, can find out the desired event folder, and when the desired event folder is detected, the cursor 35 is moved so as to specify the thumbnail images P1 to P6 of the representative image of that event folder, and after that, the jog lever 6E is depressed and operated, thereby making it possible to decide that event folder as a selection object. As a result, the voice file within the event folder thus decided is reproduced, and the reproduced voice is outputted from the speaker 32 (FIG. 5).

In this manner, in this IC recorder 1 fitted with a camera, the desired event folder can be retrieved based on the representative image set for each event folder.

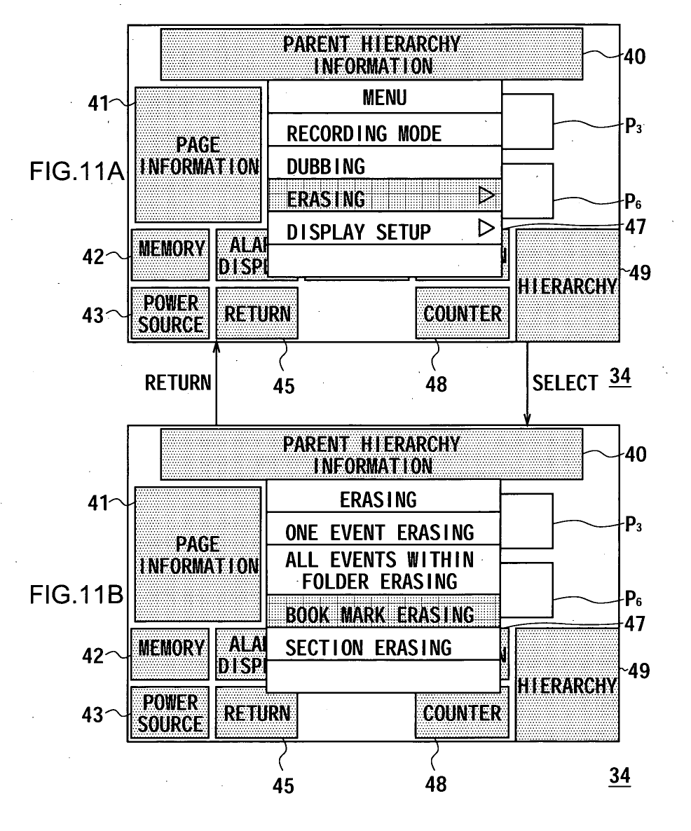

Incidentally, in the event folder selection screen 33, in case the jog lever 6E is depressed long to the fast forwarding (“FF”) side or the fast rewinding (“FR”) side during stopping reproduction of the voice file, as shown in FIGS. 11A and 11B, the cursor 35 is allowed to move at a low speed (for example, 0.4 “sec/event”) for the initial three seconds, and for the three seconds after that, at a medium speed (for example, 0.2 “sec/event”), and further, after that, at a high speed (for example, 0.2 “sec/page (6 events)”). However, when the cursor moves from the last event folder (event folder prepared at last) within the folder to the starting head event folder (event folder prepared at first) within that folder or moves in reverse, the continuous forwarding or rewinding as described above is stopped once, and the continuous forwarding or rewinding is started again from the beginning (cursor starts moving from the low speed).

In this manner, in this IC recorder 1 fitted with a camera, the moving speed of the cursor 35 is changed according to the operating state of the jog lever 6E, so that the user can access to the desired event folder much faster.

(5) Erasing Mode Function

Here, in the IC recorder 1 fitted with a camera according to the present embodiment, as an erasing mode, there are four types of erasing modes available such as “one event erasing” for erasing in a unit of event folder, “all events within folder erasing” for erasing all the event folders within the folder, “book mark erasing” for erasing the specified book mark within each event folder, and “section erasing” for erasing image and voice between the book marks within each event folder.

In a state in which the book mark image selection screen 34 is actually displayed in the LCD 7 (FIG. 5), when the menu button 6D is depressed and operated by the user, the CPU 24 (FIG. 5) of the controller 23 executes erasing processing according to the erasing mode in conformity to erasing mode processing procedure RT1 shown in FIG. 10.

That is, the CPU 24, when the menu button 6D is depressed and operated by the user, starts this erasing mode processing procedure RT1 at step SP0, and at the subsequent step SP1, the book mark image selection screen 34 displayed in the LCD 7 is superposed and displayed with a menu screen 50 shown in FIG. 11A.

Advancing to step SP2, when an “erasing” is selected from among various items of this menu screen 50, the CPU 24 advances to step SP3, and shifts to an erasing screen 51 (FIG. 11B) showing the “erasing”, and after that, determines which of the “one event erasing”, the “all events within folder erasing”, the “book mark erasing” and the “section erasing” is selected or not selected from among various items of the erasing screen 51.

When the “one event erasing” is selected from among the items by the user, the CPU 24 advances to step SP4, and executes the one event erasing processing, and after that, advances to step SP8. Further, when the “all events within folder erasing” is selected by the user, the CPU 24 advances to step SP5, and executes the “all events within folder erasing” processing, and after that, advances to step SP8. Further, when the “book mark erasing” is selected by the user, the CPU 24 advances to step SP6, and executes the “book mark erasing” processing, and after that, advances to step SP8. Further, when the “section erasing” is selected by the user, the CPU 24 advances to step SP7, and executes the “section erasing” processing, and after that, advances to step SP8.

In this step SP8, the CPU 24 returns and shifts to the original menu screen 50 from the display content according to each processing of the “one event erasing”, the “all events within folder erasing”, the “book mark erasing” or the “section erasing”, and after that, advances to step SP9, and withdraws from the menu screen, and advances straightway to the step SP10, thereby completing the erasing mode processing procedure RT1.

(5-1) One Event Erasing Processing

In step SP3 of the erasing mode processing procedure RT1 shown in FIG. 10, when the “one event erasing” is selected from among various items of the erasing screen 51 (FIG. 11B), the CPU 24 advances to step SP4, and executes the one event erasing processing. This one event erasing processing will be described below.

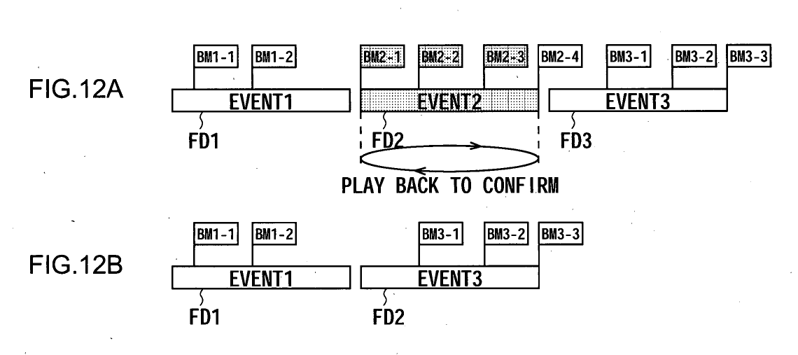

As shown in FIG. 12A, in case three event folders (hereinafter these are referred to as first to third event folders) FD1 to FD3 represented by an “event 1”, an “event 2” and an “event 3” are stored within the specified folder, when the second event folder FD2 is taken as an erasing object, it is repeatedly reproduced for a predetermined period of time (for example, approximately five seconds) until the erasing is executed, thereby prompting the user to confirm the erasing.

When the second event folder FD2 is erased, the image file of the voice file and all the book mark images (“BM2-1”, “BM2-2”, “BM2-3”, and “BM2-4”) corresponding to the second even folder are erased. As a result, as shown in FIG. 12B, a reproduction position is shifted to the third event folder FD3 in replacement of the second event folder FD2.

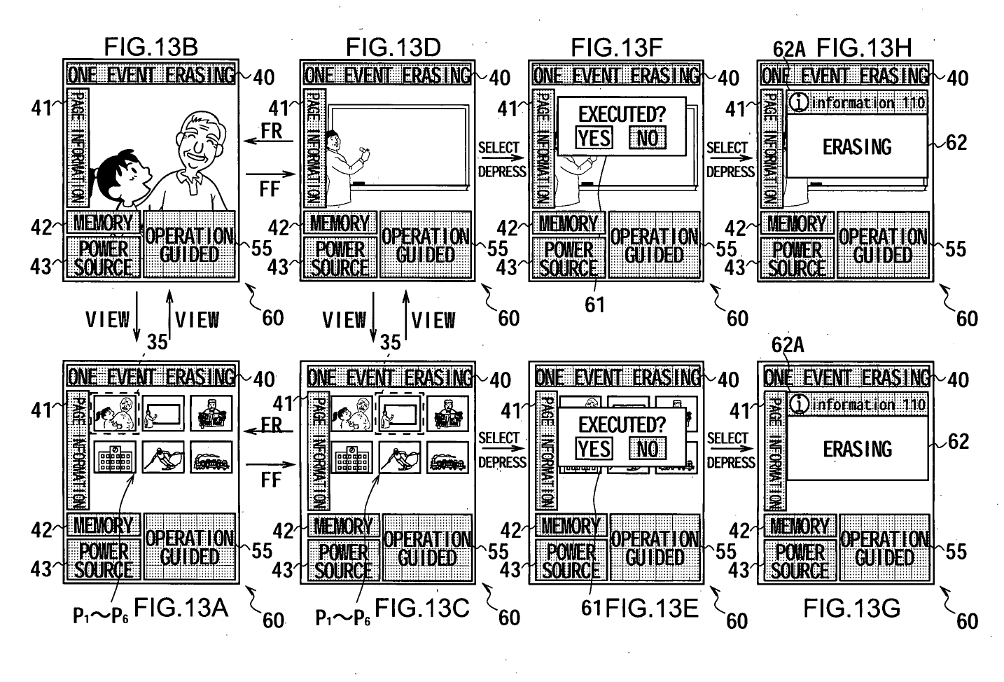

To be specific, one event erasing screen 60 as shown in FIG. 13A is shifted from the erasing screen 51 (FIG. 11B), and is displayed in the LCD 7. In this case, this one event erasing screen is provided with the parent hierarchy information display 40 displayed as the “one event erasing”, the page information display 41, for example, including a scroll bar, a memory remaining amount display 42 and the power source remaining amount display 43 for displaying the memory remaining amount of the flush memory 30 or the energy remaining amount of the power source, and an operation guide display 55 for displaying the operation content.

In the one event erasing screen 60 also, at the initial time, with regard to the upper six event folders that are early in the preparation date from among each of the event folders stored in the selected folder, the thumbnail images P₁ to P₆ of the book mark images set in advance as the representative images of the event folder are displayed in a list.

In such one event erasing screen 60, in a state in which the cursor 35 is pointed to the thumbnail image P₁ at the starting head, when the user operates the job lever 6E in such a manner as to push it down to a predetermined direction (“VIEW”), the thumbnail image is displayed in a full screen as shown in FIG. 13.

In these one event erasing screens 60 displayed with the thumbnails (FIG. 13A) or displayed in a full screen (FIG. 13B), when the user operates the jog lever to push it down to the fast forwarding (“FF”) side or the rewinding (“FR”) side, in the case of the thumbnail display, the cursor 35 moves in order so as to specify the next or preceding thumbnail images P1 to P6 (FIG. 13C), while in the case of the full screen display, the next or preceding thumbnail images P₁ to P₆ are displayed in order in a full screen (FIG. 13D).

In a state in which the cursor 35 is pointed to the thumbnail images P₁ to P₆ within the desired event folder or the thumbnail images are displayed in a full screen, when the user depresses and operates the job lever 6E, the execution confirmation screen 61 for enquiring whether or not the erasing is executed is superposed and displayed in the one event erasing screen 60 (FIG. 13E or 13F).

In an execution confirming screen 61 superposed and displayed in this one event erase screen 60, when the user depresses and operates the job lever 6E in a state in which “YES” is selected, the screen is changed to an erasing execution screen 62 showing that the event folder is in the midst of being erased (FIG. 13G or 13H). This erasing execution screen 62 is displayed with a character of “erasing” on a large scale, and at the same time, an “i” mark 62A on the upper left side turns on and off.

Such erase execution screen 62 is displayed during the period of time (however, at least more than one second) until the voice file (compressed voice data D2) within the event folder decided as the erasing object and the image files (compressed image data D4) of all the book mark images are erased. As a result, the user can visually recognize that these files are all being erased.

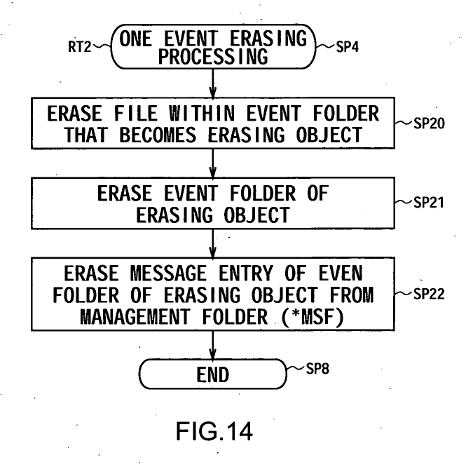

Incidentally, when the signal processing by the CPU 24 enters step SP4 of the erasing mode processing procedure RT1 shown in FIG. 10, the procedure shifts to a one event erasing processing procedure RT2 shown in FIG. 14 with the step SP4 as a sub routine. At step SP 20 of this one event erasing processing procedure RT2, the CPU 24 erases the voice file within the event folder which becomes the erasing object and the image files of all the book mark images, and after that, advances to step SP21, and erases that event folder.

The CPU 24, at step SP22, erases the message entry (“Message Entry”) for the event folder that becomes the erasing object within the folder from the management file (“MSGLIST.MSF” of FIG. 8), and after that, advances to step SP8 of the erasing mode processing procedure RT1 shown in FIG. 10, and at the same time, completes the one event erasing processing procedure RT2.

(5-2) All Events within Folder Erasing Processing

In step SP3 of the erasing mode processing procedure RT1 shown in FIG. 10, when the “all events within folder erasing” is selected from among various items of the erasing screen 51 (FIG. 11B), the CPU 24 advances to step SP4, and executes the all events within folder erasing processing. This all events within folder erasing processing will be described below.

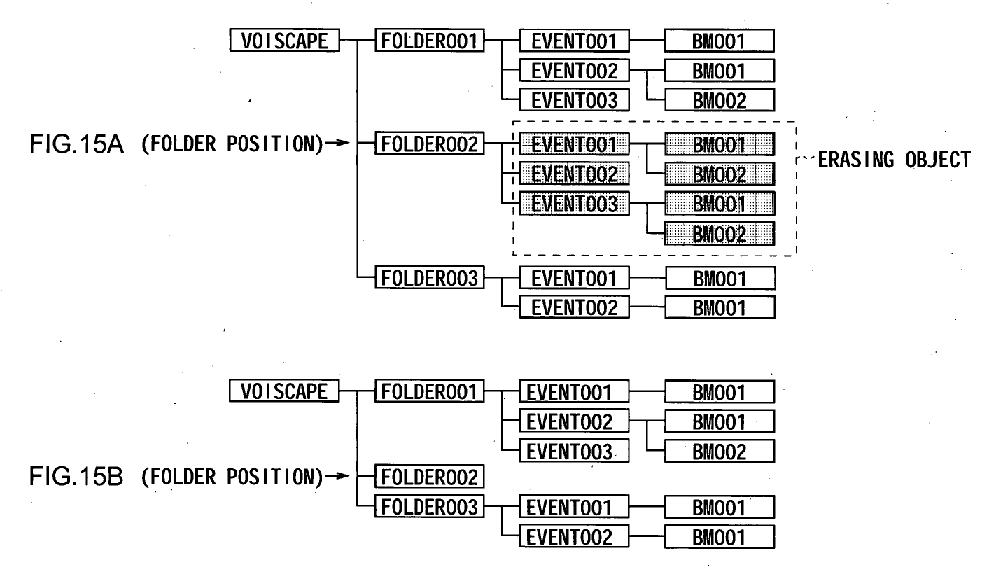

Similarly to FIG. 15A, all the event folders (“0001” to “0003”) within the specified folder (“002”) from among all the folders (“FOLDER 1” to “FOLDER 3”) existing in the “VOISCAPE” are erased. At this time, the voice file corresponding to all the event folders within the folder (“002”) and the image files of the all the book mark images (“BM001” and “BM002”) added to this file are erased (broken line range of the figure).

As a result, as shown in FIG. 15B, the position of the folder (“002”) after the erasing does not change, and in this regard, it is different from the case of the one event erasing processing. Further, even to the extent that confirmation reproduction is not performed, it is different from the one event erasing processing.

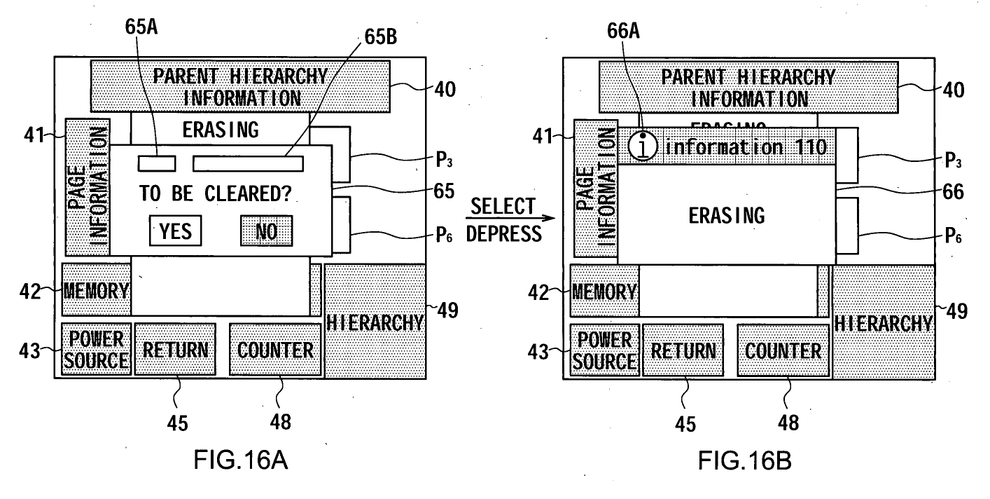

To be specific, the erasing screen 51 (FIG. 11B) is superposed and displayed with an execution confirming screen 65 shown in FIG. 16A. In this case, this execution confirming screen 65 is displayed with an icon 65A of the folder at the reproduction position and a nomenclature 65B, and at the same time, a note to the effect that the folder may be emptied or not and a “YES” or “NO” button are displayed.

In this execution confirming screen 65, when the user depresses and operates the jog lever 6E in a state in which the “YES” button is selected, the screen is changed to an erasing execution screen 66 indicating that all the event folders within the specified folder is being erased (FIG. 16B). This erasing execution screen 66 is displayed with a character of “erasing” on a large scale, and at the same time, an “i” mark 66A on the upper left side turns on and off.

Such erasing execution screen 66 is displayed during the period of time (however, at least more than one second) until the voice file (compressed voice data D2) in all the event folders within the folder decided as the erasing object and the image files (compressed image data D4) of all the book mark images are erased. As a result, the user can visually recognize that these files are all being erased.

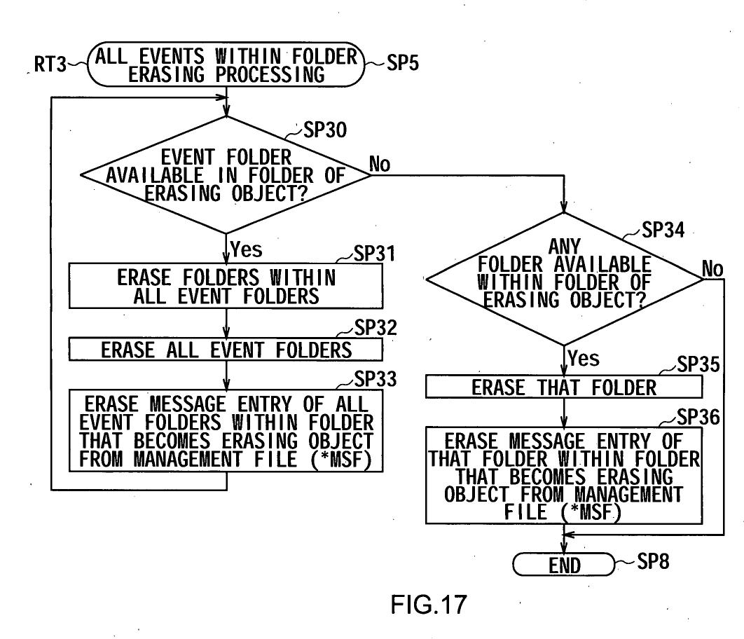

Incidentally, when the signal processing by the CPU 24 enters step SP5 of the erasing mode processing procedure RT1 shown in FIG. 10, the procedure shifts to an all events within folder erasing processing RT3 shown in FIG. 17 with the step SP5 as a sub routine.

At step SP30 of this all events within folder erasing processing procedure RT3, the CPU 24 determines whether or not there exists a event folder within the folder that becomes the erasing object, and in case an affirmative result is obtained, advances to step SP31, and erases the voice files within all the event files that become the erasing object and the image files of all the book mark images.

Subsequently, the CPU 24 advances to step SP32, and erases all the event folders, and after that, at step SP33, erases the message entry (“Message Entry”) for all the event folders within the folder that become the erasing object from the management file (“MSGLIST.MSF” of FIG. 8), and after that, returns to step SP30 again, and repeats the same processing as described above.

In contrast to this, when a negative result is obtained at step SP30, this means that there does not exist a event folder within the folder that becomes the erasing object, and at this time, the CPU 24 advances to step SP34, and determines whether or not there exists any folder within the folder that becomes the erasing object.

In case an affirmative result is obtained at step SP34, the CPU 24 advances to step SP35, and erases the existing folder, and after that, at the subsequent step SP36, erases the message entry (“Message Entry”) for the folder within the folder that becomes the erasing object from the management file (“MSGLIST.MSF” of FIG. 8), and after that, advances to step SP8 of the erasing mode processing procedure RT1 shown in FIG. 10, and at the same time, completes the all events within folder erasing processing procedure.

In the meantime, in case a negative result is obtained at this step SP34, the CPU 24 does not perform any processing, and advances to step SP8 of the erasing mode processing procedure RT1 shown in FIG. 10, and at the same time, completes the all events within folder erasing processing procedure RT3.

(5-3) Book Mark Erasing Processing

At step SP3 of the erasing mode processing procedure RT1 shown in FIG. 10, when a “book mark erasing” is selected from among various items of the erasing screen 51 (FIG. 11B), the CPU 24 advances to step SP6, and executes the book mark erasing processing. This book mark erasing processing will be described below.

As its premise, the IC recorder 1 fitted with a camera is mounted with a book mark registering function, which registers each still image photographed by the user in a desired timing at the recording time as a book mark in association with the voice file of the voice recorded, and can reproduce with a point of time when the book mark within the event folder specified at the reproduction time exists taken as a reproduction position.

Such a book mark can be registered not only at the audio recording time but also at the reproduction time, and with regard to each event folder, adds a book mark foe each event folder within each folder registered and stored in the flush memory 30 (FIG. 5) at the timing desired by the user or performs photographing operations, and can register the book mark or the photographed still image (that is, book mark image) in the flush memory 30 in association with the voice file of the corresponding voice.

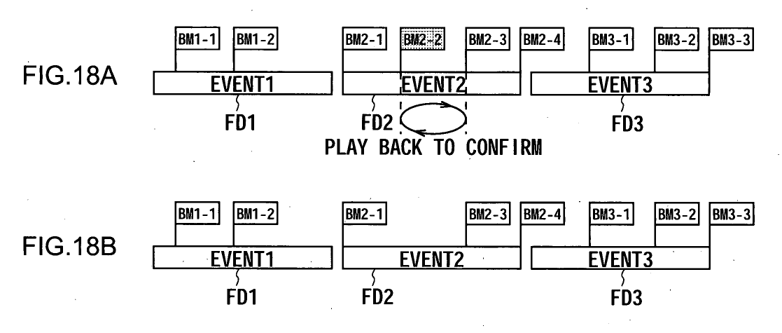

Similarly to FIG. 18A, in case the first to third event folders FD1 to FD3 represented by the “event 1”, the “event 2”, and the “event 3” are stored within the specified folder, when the second book mark (“BM2-2”) in the second event folder FD2 is specified as the erasing object, the section from the book mark (“BM2-2”) to the next book mark (“BM2-3”) is repeatedly reproduced for a predetermined period of time (for example, approximately five seconds), thereby prompting the user to confirm the erasing.

As a result, as shown in FIG. 18B, the second book mark image alone within the second event folder FD2 specified by the user is erased.

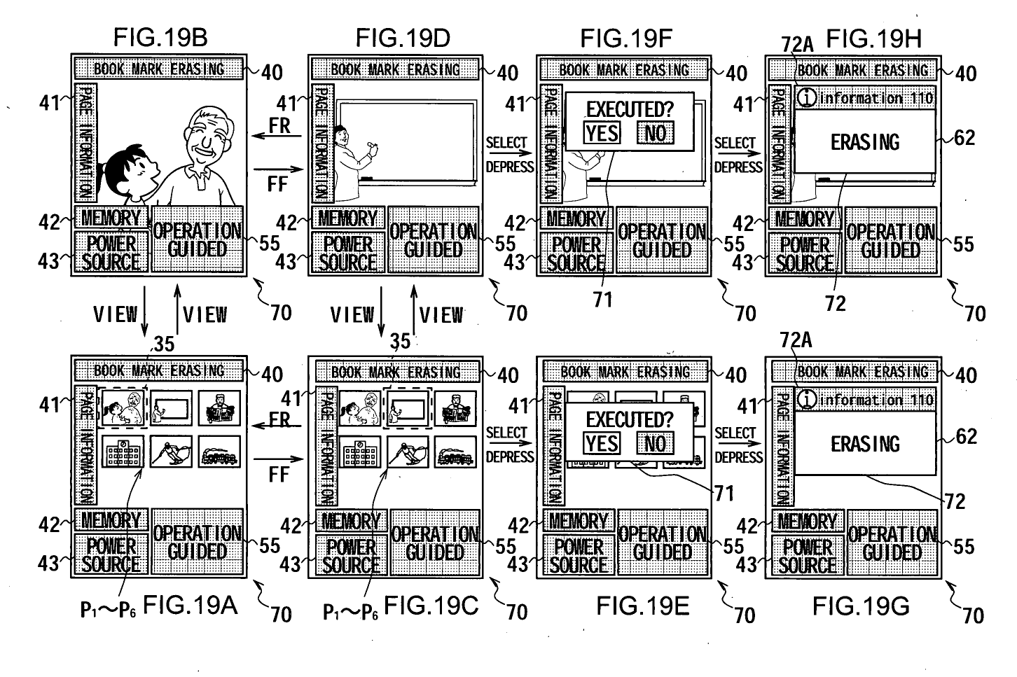

To be specific, a book mark erasing screen 70 shown in FIG. 19A is shifted from the erasing screen 51 (FIG. 11B) and displayed in the LCD 7. In this case, this book mark erasing screen 70 is provided with the parent hierarchy information display 40 displayed as “book mark erasing”, the page information display 41, the memory remaining amount display 42, the power source remaining amount display 43, and the operation guide display 55.

Even in the book mark erasing screen 70, at the initial time, with regard to the upper six event folders that are early in the preparation date from among each of the event folders stored in the selected folder, the thumbnail images P₁ to P₆ of the book mark images set in advance as the representative images of the event folder are displayed in a list.

In such book mark erasing screen 70, in a state in which the cursor 35 is pointed to the thumbnail image at the starting head, when the user operates the job lever 6E in such a manner as to push it down to a predetermined direction (“VIEW”), the thumbnail image is displayed in a full screen as shown in FIG. 19B.

In these book mark erasing screens 70 displayed with the thumbnail (FIG. 19A) or displayed in a full screen (FIG. 19B), when the user operates the jog lever to push it down to the fast forwarding (“FF”) side or the rewinding (“FR”) side, in the case of the thumbnail display, the cursor 35 moves in order so as to specify the next or preceding thumbnail images P₁ to P₆ (FIG. 19C), while in the case of the full screen display FIG. 19C, the next or preceding thumbnail images P₁ to P₆ are displayed in order in a full screen (FIG. 19D).

In a state in which the thumbnail images P₁ to P₆ of the desired event folder are pointed by the cursor 35 by the user or are displayed in a full screen, when the jog lever 6E is depressed and operated, an execution confirming screen 71 inquiring whether or not the erasing is executed is superposed and displayed in the book mark erasing screen 70 (FIG. 19E or 19F).

In the execution confirming screen 71 superposed and displayed in this book mark erasing screen 70, when the jog lever 6E is depressed and operated by the user in a state in which “YES” is selected, the screen is changed to an erasing execution screen 72 indicating that the book mark image is in the midst of being erased (FIG. 19G or 19H). This erasing execution screen 72 is displayed with a character of “erasing” on a large scale, and at the same time, an “i” mark 72A on the upper left side turns on and off.

Such erase execution screen 72 is displayed during the period of time (however, at least more than one second) until the image file (compressed image data D4) of the book mark image decided as the erasing object within the event folder is erased. As a result, the user can visually recognize that the file is being erased.

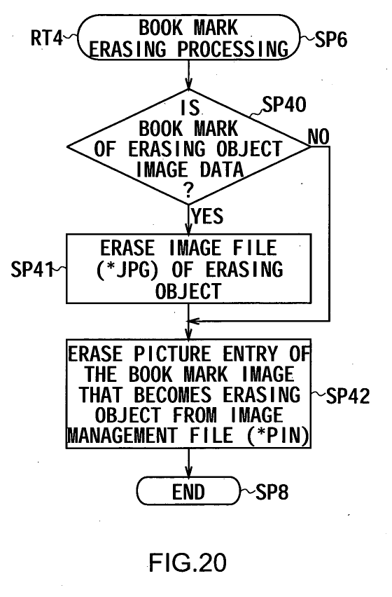

Incidentally, when the signal processing by the CPU 24 enters step SP6 of the erasing mode processing procedure RT1 shown in FIG. 10, the procedure shifts to a book mark erasing processing procedure RT4 shown in FIG. 20 with the step SP6 taken as a sub routine. At step SP 40 of this book mark erasing processing procedure RT4, the CPU 24 determines whether or not the book mark image that becomes the erasing object within the specified event folder is an image based on the image data.

In case an affirmative result is obtained at this step SP40, the image file of the book mark image that becomes the erasing object is erased, and after that, the procedure advances to step SP41, and erases the picture entry (“Picture Entry”) for the book mark image that becomes the erasing object within the event folder from the image management file (“03072400.PIN” of FIG. 8), and after that, advances to step SP8 of the erasing mode processing procedure RT1 shown in FIG. 10, and at the same time, completes the book mark erasing processing procedure RT4.

(5-4) Section Erasing Processing

At step SP3 of the easing mode processing procedure RT1 shown in FIG. 10, when a “section erasing” is selected from among various items of the erasing screen 51 (FIG. 11B), the CPU 24 advances to step SP7, and executes a section erasing processing. This section erasing processing will be described below.

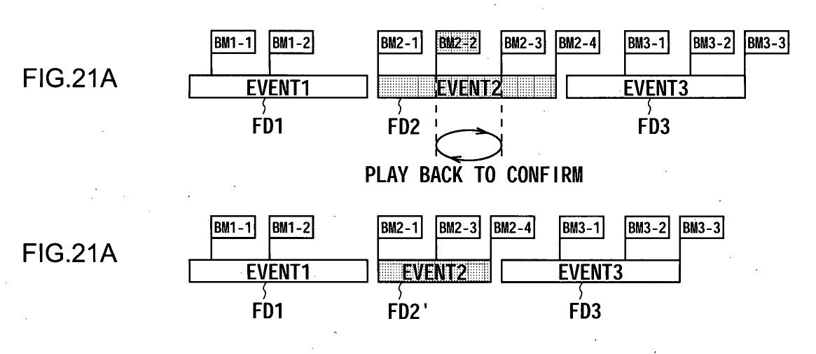

Similarly to FIG. 21A, in case the first to third event folder FD1 to FD3 represented by the “event 1”, the “event 2”, and the “event 3” are stored within the specified folder, when a section (hereinafter, this is referred to as book mark section) from the second book mark (“BM2-2”) in the second event folder FD2 to the next third book mark (“BM2-3”) is taken as an erasing object, the book mark section is repeatedly reproduced for a predetermined period of time (for example, approximately five seconds), thereby prompting the user to confirm the erasing.

Subsequently, it is decided by the instruction of the user which book mark image from the second book mark (“BM2-2”) or the third book mark (“BM2-3”) within the second event folder is erased. In the present embodiment, the second book mark image is erased.

Incidentally, in case the book mark selected as the erasing object exists in the last position of the event folder, though the voice actually recorded does not exist, the book mark can be erased.
As a result, the voice file in the book mark section from the second book mark (“BM2-2”) to the third book mark (“BM2-3”) within the second book folder FD2 specified by the user is erased, and at the same time, the image file of the book mark image specified from among the second or the third book mark is erased, and after that, as shown in FIG. 21B, the book mark section erased in the second event folder FD2 is connected.

Incidentally, in case the book mark section is erased during reproduction, the reproduction is stopped during the erasing processing, and after the completion of the erasing, the reproduction for the next event folder is started.

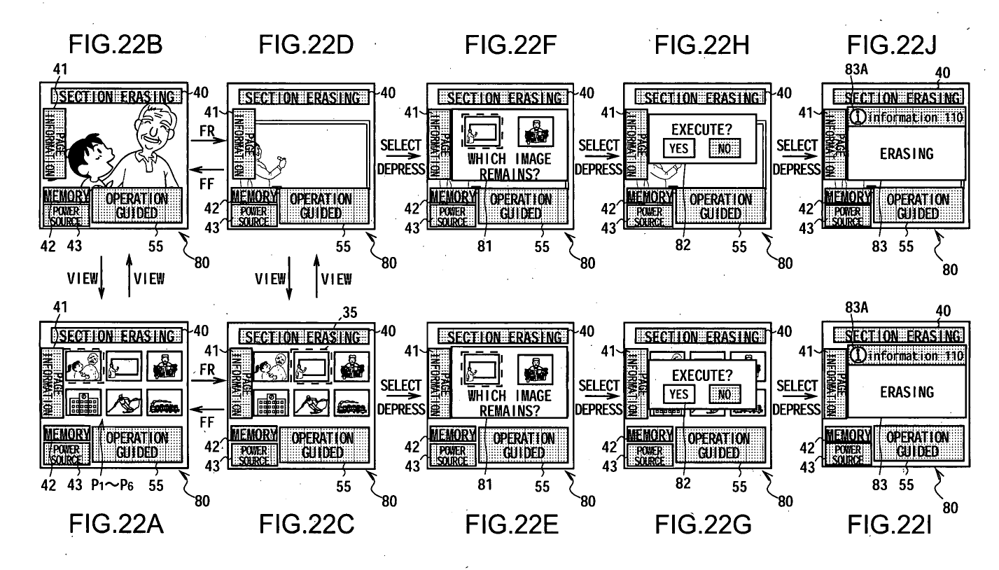

To be specific, a section erasing screen 80 shown in FIG. 22A is shifted from the erasing screen 51 (FIG. 11B), and is displayed in the LCD 7. In this case, the section erasing screen 80 is provided with the parent hierarchy information display 40 displayed as “section erasing”, the page information display 41, the memory remaining amount display 42, the power source remaining amount display 43, and the operation guide display 55.

In the section erasing screen 80 also, at the initial time, with regard to the upper six event folders that are early in the preparation date from among each of the event folders stored in the selected folder, the thumbnail images P₁ to P₆ of the book mark images set in advance as the representative images of that event folder are displayed in a list.

In such section erasing screen 80, in a state in which the cursor 35 is pointed to the thumbnail image at the starting head, when the user operates the job lever 6E in such a manner as to push it down to a predetermined direction (“VIEW”), the thumbnail image is displayed in a full screen as shown in FIG. 22B.

In the section erasing screen 80 displayed with the thumbnails (FIG. 22A) or displayed in a full screen (FIG. 22B), when the user operates the jog lever 6E to push it down to the fast forwarding (“FF”) side or the rewinding (“FR”) side, in the case of the thumbnail display, the cursor 35 moves in order so as to specify the next or preceding thumbnail images P₁ to P₆ (FIG. 22C), while in the case of the full screen display, the next or preceding thumbnail images P₁ to P₆ are displayed in order in a full screen (FIG. 22D).

In a state in which the thumbnail images P₁ to P₆ of the desired event folder are pointed by the cursor 35 by the user or displayed in a full screen, when the jog lever 6E is depressed and operated, the book mark section corresponding to the thumbnail images from that book mark to the next book mark is erased, and at the same time, a remaining image deciding screen 81 for enquiring which book mark image is erased or not is superposed and displayed in the screen 80 (FIG. 22E or 22F).

When the book mark image to remain in this remaining image deciding screen 81 is decided, the screen is changed to an execution confirming screen 82 for enquiring whether or not the book mark section is erased from the remaining image deciding screen 81 (FIG. 22G or 22H).

Incidentally, in the section erasing screen 80 displayed with the thumbnails (FIG. 22C) or displayed in a full screen (FIG. 22D), in case there does not exist the next book mark of the book mark selected by the user, the screen is changed straightway to the execution confirming screen 82 without displaying the remaining image deciding screen 81.

In the execution confirming screen 82 superposed and displayed in this section erasing screen 80, when the user depresses and operates the job lever 6E in a state in which “YES” is selected, the screen is changed to an erasing execution screen 83 showing that the book mark section is in the midst of being erased (FIG. 22I or 22J). This erasing execution screen 83 is displayed with a character of “erasing” on a large scale, and at the same time, an “i” mark 83A on the upper left side turns on and off.

Such erase execution screen 83 is displayed during the period of time (however, at least more than one second) until the voice file (compressed voice data D2) in the book mark section decided as the erasing object within the folder and the image file (compressed image data D4) are erased. As a result, the user can visually recognize that these files are a being erased.

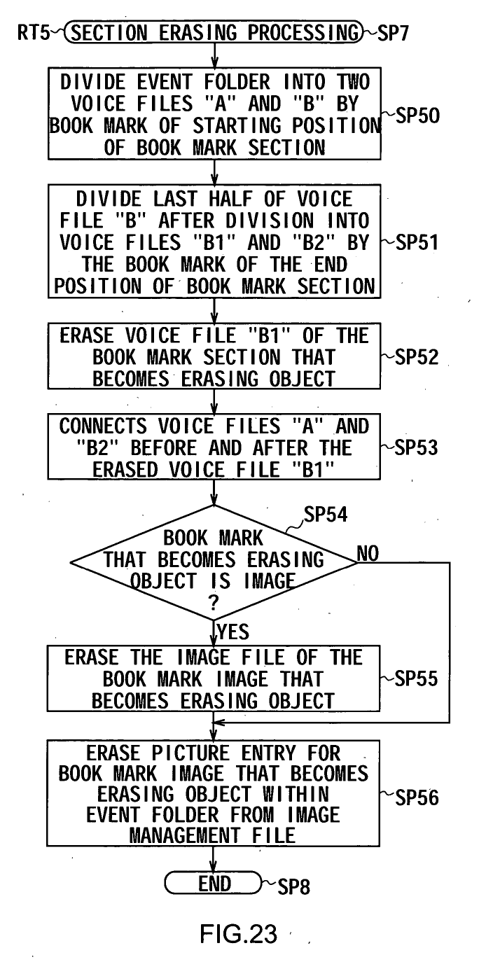

Incidentally, when the signal processing by the CPU 24 enters step SP7 of the erasing mode processing procedure RT1 shown in FIG. 10, the procedure shifts to a section erasing processing procedure RT5 shown in FIG. 23 with the step SP7 taken as a sub routine. At step SP 50 of this section erasing processing procedure RT5, the CPU 24 divides the event folder into two pieces by the book mark of the starting position of the book mark section that becomes the erasing object within the specified event folder.

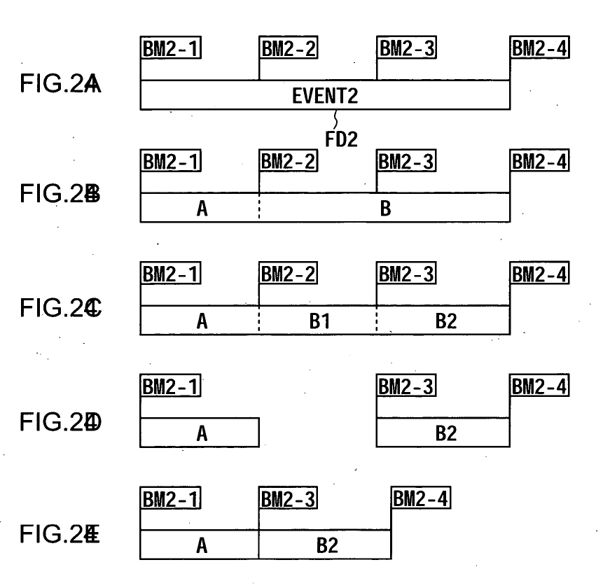

To be specific, describing the second event folder FD2 shown in FIG. 21A in detail in connection with FIGS. 24A to 24E, first, the event folder is divided into voice files “A” and “B” in the second book mark (“BM2-2”) within this second event folder FD2 (FIG. 24A and 24B).

Subsequently, the CPU 24 advances to step SP51, and divides the voice file of the last half after the division into tow pieces by the book mark of the last position of the book mark section. That is, similarly to FIG. 24C, the voice file “B” of the last half divided by the second book mark (“BM2-2”) in the second event folder FD2 is divided into voice files “B1” and “B2” by the third book mark (“BM2-3”) of the last position of the book mark section.

The CPU 24 advances to step SP 52, and erases the voice file of the book mark section that becomes the erasing object, and at the subsequent step SP 53, connects the voice files to each other before and after the erased voice file. That is, similarly to FIG. 24D, the voice file “B1” of the book mark section is erased, and after that, similarly to the subsequent FIG. 24E, the voice files “A” and “B2” before and after the erased voice file “B1” are connected to each other.

After that, the CPU 24, at step SP 54, determines whether or not the book mark that becomes the erasing object is a image based on the image data, and in case an affirmative result is obtained, advances to step SP 55, and erases the image file of the book mark that becomes the erasing object, and after that, advances to step SP 56. In the meantime, at step SP 54, in case a negative reply is obtained, the CPU 24 advances straight way to step SP 56.

In such step SP 56, the CPU 24 erases the picture entry (“Picture Entry”) for the book mark image that becomes the erasing object within the event folder from the image management file (“03072400.PIN” of FIG. 8), and after that, advances to step SP 8 of the erasing mode processing procedure RT1 shown in FIG. 10, and at the same time, completes the section erasing processing procedure RT5.

(6) Operation and Advantages of the Present Embodiment

In the above described configuration, this IC recorder 1 fitted with a camera registers each still image photographed in the timing desired by the user during audio recording as a book mark image in the flush memory 30 in association with the voice file of the recorded voice.

Further, the IC recorder 1 fitted with a camera, with regard to each event folder, adds a book mark foe each event folder within each folder registered and stored in the flush memory 30 at the timing desired by the user or performs photographing operations, and registers the book mark or the photographed still image (that is, book mark image) in the flush memory 30 in association with the voice file of the corresponding voice.

The IC recorder 1 fitted with a camera, when one folder (“FOLDER 1” to “FOLDER 3” of FIG. 7) is selected and is given the display instruction of the book mark image selection screen 34, with regard to each voice file (each event folder) within the folder, the thumbnail images P₁ to P₆ of the book mark image registered and stored in association with such voice file are prepared, and are displayed in a list in the book mark selection screen 34.

Here, in this IC recorder 1 fitted with a camera, with regard to the event folder selected by the user, when the book mark section from the kth book mark to the next (k+1)th book mark is specified as the erasing object, after the voice file in the book mark section is erased, the voice files before and after such book mark section are connected to each other.

At this time, in this IC recorder 1 fitted with a camera, with regard to the book mark section specified by the user, when either of the kth or (k+1)th book mark image is specified as the erasing object, the image file only of the book mark image specified by the user is erased.

In this manner, in this IC recorder 1 fitted with a camera, in case an unnecessary portion from among the voice files registered and stored in the flush memory 30 is erased, based on each book mark image displayed in a list as the thumbnail images P₁ to P₆ in the book mark image selection screen 34, the voice files before and after of the book mark section can be connected to each other.

Consequently, since this IC recorder 1 fitted with a camera can specify the book mark section that becomes the erasing object, while directly observing each book mark image displayed in a list, comparing with the case where a series of operations are performed as in the past in which the starting point of time and the end point of time of the unnecessary portion are specified and a file is prepared, and after that file is erased, the divided files are connected to each other, the voice file can be exceptionally quickly and easily edited, thereby exceptionally enhancing editing properties.

According to the above described configuration, in this IC recorder 1 fitted with a camera, in case au necessary portion from among the voice files recorded and stored in the flush memory 30 is erased, based on each book mark image displayed in a list as the thumbnail images P₁ to P₆ in the book mark image selection screen 34, only by specifying the book mark section, the voice file of the book mark section is erased, and after that, the voice files before and after that book mark section are connected to each other, so that the IC recorder 1 fitted with a camera can be realized in which the user can use the book mark image for editing purpose, thereby enhancing editing properties of the file on the desired voice information so as to enhance exceptionally the usability.

(7) Other Embodiments

Incidentally, in the above described embodiment, while a description has been made on the case where the present invention is applied to the IC recorder (IC recorder 1 fitted with a camera), the present invention is not limited to this, but can be widely applied to various types of other recording and reproducing devices. In this case, even if such recording and reproducing device adapts recording medium other than the flush memory 30 as the recording medium to record and store the voice file and image file obtained by audio recording and photographing, it can be applied to the present invention.

Further, in the above described embodiment, while a description has been made on the case where the thumbnail images P₁ to P₆ of the image set up as the representative image of the event file in the event file selection screen 33 and the book mark image selection screen 34 are allowed to display six pieces, the present invention is not limited to this, but the number of such thumbnail images P₁ to P₆ displayed in the event file selection screen 33 and the like may be other than six pieces.

Further, in the above described embodiment, a description has been made on the case where, when a portion of the file on the selected voice information is taken as unnecessary, the jog lever 6E is adapted as an image specifying unit for specifying each image located at the starting point of time and the end point of time of the portion of the file from among each image displayed in a display unit, and according to the display content of the section erasing screen 80 in FIGS. 22A to 22J, the jog lever 6E is operated, but the present invention is not limited to this, and may be adapted to an image specifying unit of other various configurations.

Further, in the above described embodiment, while a description has been made on the case where a portion of the file corresponding to the section from the image of the starting point of time specified by the job lever (image specifying unit) 6E to the image of the end point of time is erased, and after that, as an editing unit for connecting the remainder of the files before and after that section, the CPU 24 is adapted, but the present invention is not limited to this, and in brief, if the user can use the image (book mark image) for the ear mark of the editing, the invention may be adapted to the editing unit of other various configurations.

The present invention can be widely applied to other various recording and reproducing devices, in addition to the IC recorder fitted with a camera.

It should be understood by those skilled in the art that various modifications, combinations, sub-combinations and alterations may occur depending on design requirements and other factors insofar as they are within the scope of the appended claims or the equivalents thereof.

What is claimed is:

1. A portable type recording and reproducing device, comprising:
a voice collection unit collecting external voice and outputting voice information according to a voice collection result;
an imaging unit imaging the outside and outputting image information according to an imaging result;
a recording unit making a file of said voice information in a unit of an event so as to be recorded in a predetermined recording medium, and at the same time, recording said image information in the recording medium in association with the file of said corresponding voice information according to external operation;
a display unit displaying each image based on said image information associated, respectively with said file of said voice information;
an image specifying unit specifying each said image located at a starting point of time and an end point of time of said file of each said image displayed in said display unit in case the file of said voice information is erased;
a file erasing unit erasing the file for said image specified by said image specifying unit; and
an editing unit erasing said file for said image specified by said file erasing unit, and after that, connecting the remaining portion of said files before and after the section of said erased file.

2. The recording and reproducing device according to claim 1, wherein said editing unit erases only an image from either the image of said starting point of time or the image of said end point of time which is specified by said image specifying unit.

3. The recording and reproducing device according to claim 1, wherein said editing unit erases the image only of said point of time in case a portion of said file does not exist at said end point of time.

4. A recording and reproducing method, comprising:
a first step of filing voice information obtained by collecting external voice in an unit of event so as to be recorded in a predetermined recording medium, and at the same time, recording said image information obtained by imaging the outside in the recording medium in association with the file of said voice information according to external operation;
a second step of displaying each image based on said image information associated, respectively with said file of said voice information;
a third step of specifying each said image located at the starting point of time and the end point of time of said file of each said file displayed in case the file of said voice information is erased;
a fourth step of erasing the file for said specified image; and
a fifth step of connecting the remainder of said files before and after the section of said erased file after said file for the said specified image is erased.

5. The recording and reproducing method according to claim 4, wherein, at said fifth step, only a specified image from either the image of said starting point of time or the image of said end point of time is erased.

6. The recording and reproducing method according to claim 4, wherein, at said fifth step, in case a portion of said file does not exist at said end point of time, the image only at said end point of time is erased.

7. A program, allowing a computer to execute:
a first step of filing voice information obtained by collecting external voice in an unit of event so as to be recorded in a predetermined recording medium, and at the same time, recording said image information obtained by imaging the outside in the recording medium in association with the file of said corresponding voice information according to external operation;
a second step of displaying each image based on said image information associated, respectively with said file of each said voice information;
a third step of specifying each said image located at the starting point of time and the end point of time of said file of each said image displayed in case the file of said voice information is erased;
a fourth step of erasing the file for said specified image; and
a fifth step of connecting the remainder of said files before and after the section of said erased file after said file for the said specified image is erased.

8. The program according to claim 7, wherein, at said fifth step, only the specified image from either the image at said starting point of time or the image at said end point of time is erased.

9. The program according to claim 7, wherein, at said fifth step, in case a portion of said file does not exist at said end point of time, only the image at the end point of time is erased.
